(19) United States
(12) Patent Application Publication
(10) Pub. No.: US 2007/0208503 A1
(43) Pub. Date: Sep. 6, 2007

(54) System and method for documenting a travel event

(76) Inventor: James Harnsberger, San Diego, CA (US)

Correspondence Address: James Harnsberger, 4686-B Mercury St., San Diego, CA, 92111, US

(21) Appl. No.: 11/367,577

(22) Filed: Mar. 2, 2006

(51) Int. Cl. G01C 21/32

(52) U.S. Cl. 701/208; 701/211

(57) ABSTRACT

A system and method for documenting a travel event and designating the travel event as business or personal. A portable computing device configured to obtain location and time is used for querying a user when location changes to determine if the travel event is personal or business related. The portable computing device saves the selection and records the location during the travel event. When the location no longer changes for a configurable time, the traveler is asked to confirm that the travel event has completed. The destination location is then saved. Optionally, the traveler may save picture, video, audio, map data at the point of departure, during the travel event or at travel completion. The additional information may be used as evidence that the travel event took place and when and where it took place. The information saved may be integrated with external programs such as a spreadsheet or word processor.

### BACKGROUND OF THE INVENTION

1. Field of the Invention

Embodiments of the invention described herein pertain to the field of travel accounting. More particularly, but not by way of limitation, one or more embodiments of the invention enable a system and method for documenting a travel event and designating the travel event as business or personal.

2. Description of the Related Art

Documenting travel events as personal or business allows individuals to maintain accurate records for business, employment, personal, tax, insurance or legal purposes. Many private and government organizations have a need for recording travel events associated with employees. Employees such sales personnel, real estate professionals, repair personnel and others are generally required to travel for business purposes and document that travel for reimbursement or tax related purposes. In addition, certain local, county, state and federal government agencies provide a mileage allowance for government employees that the employees are responsible for documenting.

There are no known standalone systems for documenting travel as personal or business related. Current methods for documenting travel as personal or business related are manual oriented methods that require a traveler to carry a ledger wherever they travel and remember to document the start and end points of travel and whether the travel event is personal or business oriented. This leads to inaccurate accounting that relies on odometer readings and notation thereof for distance, and date and time notation that relies for example on a traveler's watch. The accounting in this scenario is unverifiable in that the traveler may simply edit the numbers and provide data that is inflated or may make a simple mistake in terms of a mathematical error. In either case, the data is not accurate. In addition, manual methods for documenting travel as personal or business related fail to show the travel route for example on a map that may be printed and/or saved for later use such as during a tax audit.

Portable computing devices such as cell, mobile, portable phones and wireless capable PDAs may be equipped with location determination functionality and clock functionality. Position location may be performed using triangulation between cell towers and/or may include Global Positioning Satellite (GPS) technology. Although portable computing devices may be configured with appropriate location and clock functionality these devices are currently not used for documenting travel as business or personal related. In addition, portable computing devices have sufficient processing capability and memory to include standard spreadsheet, word processing, and database software programs such as spreadsheets and editors. Furthermore, portable computing devices may be augmented via download to incorporate specifically designed software programs. There are no known software programs for documenting travel as business or personal related when a traveler begins to change location and therefore no known programs that take advantage of the processing capabilities whether custom or off the shelf in order to integrate with existing business systems. For example there are no known software programs that execute on a portable computing device that query a user as to the nature of travel and then integrate the response and travel data into a spreadsheet (such as Excel®). In addition, there are no known personal information management software (such as Outlook®) or tax software (such as QuickBooks®) solutions that allow for travel to be designated as business or personal and for the integration of the information into the software solution.

Current portable computing devices communicate with wireless transmitting and receiving towers that are installed, operated and maintained by various cell, mobile and portable phone service or provider companies. No known provider company enables customers to download a travel documentation program that enables a traveler to document a travel event as business or personal when the traveler changes location.

In addition, there are no known solutions that allow for a travel event that has been designated as business or personal to be utilized by an external company for purposes of verifying travel events such as an insurance company that may wish to provide incentives to drivers that stay under the speed limit which is based on the location of travel. There is no known solution for an insurance company to verify business versus personal travel for rate coverage incentives. There is no known solution for an insurance company to calculate dangerous hours of vehicle operation to determine for example if a young driver is often driving around closing time for drinking establishments. As a traveler attempting to hide travel at dangerous hours may not wish to carry a cell phone that would be able to track the traveler's speed and time of travel, there are no known solutions that allow for a vehicle's own on board computer to be utilized to document travel. There are no known solutions for example that enable a vehicle to query the user for business or personal travel at travel start time and download the travel speed and time information to a user's cell phone or PDA or directly over the Internet to the insurance company's server at travel completion (or at the time of an accident). There are no known solutions for providing travel data that has been designated as business or personal in an un-editable form for use in legal proceedings. In the case of travel for business, a business insurance policy may cover an accident while personal travel may be covered by a personal insurance policy. In a scenario where the same traveler in the same vehicle (car, boat, motorcycle or any other moving vehicle) may have an accident that is covered by more than one insurance policy, there are no known solutions for discerning whether the travel was pre-designated as business or personal in an unchangeable method after an accident has occurred.

For at least the limitations described above there is a need for a system and method for documenting a travel event and designating the travel event as business or personal.

### BRIEF SUMMARY OF THE INVENTION

One or more embodiments of the invention enable a system and method for documenting a travel event and designating the travel event as business or personal. Embodiments of the invention enable the automated process of documenting travel events as business or personal related and are utilized in maintaining accurate records for business, employment, personal, tax, insurance or legal purposes. Embodiments of the invention allow for private and government organizations that have a need for recording travel events associated with employees to designate travel as business or personal related.

Embodiments of the invention allow for a travel event that has been designated as business or personal to be utilized by an external company for purposes of verifying the travel event. For example, an external company such as an insurance company may provide incentives to drivers that stay under the speed limit (which is based on the location of travel). Furthermore, the insurance company may require verification of business versus personal travel for rate coverage incentives. An insurance company may also designate and obtain dangerous hours of vehicle operation to determine for example if a young driver is often driving around closing time for drinking establishments. A vehicle equipped with location determination functionality may also be utilized to document travel. In this example, the vehicle queries the traveler as to the nature of travel (e.g., business or personal travel) at travel start time and downloads the travel speed and time information to a user's cell phone or PDA or directly over the Internet to the insurance company's server at travel completion (or at the time of an accident). The travel data that has been designated as business or personal in an un-editable form may subsequently be used in legal proceedings to prove that a traveler was or was not obeying the law at the time of the accident. In the case of travel for business, a business insurance policy may cover an accident while personal travel may be covered by a personal insurance policy.

Embodiments of the invention may utilize computing devices that are portable by a human or vehicle. The term ‘portable computing device’ refers to cell, mobile, portable phones, wireless capable Personal Digital Assistant (PDA), car computer or any other computing device that is portable by a human or vehicle and that is configured to obtain location and time information or is equipped with location determination functionality and clock functionality. For example, a notebook computer with a GPS card and wireless network card is an example of a portable computing device that may be utilized in one or more embodiments of the invention. An automobile is an example of a portable computing device as modern automobiles generally have multiple central processing units. The automobile ports the central processing unit(s) coupled with the vehicle through space and time. Many automobiles and other vehicles are now available with GPS position determination functionality. Any other vehicles such as boats, motorcycles or any computer devices that may be ported by any vehicle which have at least one microprocessor and the ability to obtain location and time information are in keeping with the spirit of an invention. Time information may comprise hours, minutes, seconds and any division of a second and may also include the day of the week, the date of the month, the month and the year. Optional video displays, video cameras, sound recorders and other software functionality for performing various functions may be utilized in one or more embodiments of the invention to augment the core functionality of the system.

Embodiments of the invention obtain a location utilizing a portable computing device. After obtaining a location, embodiments of the invention query a user when the location changes and the traveler begins a travel event. The query may be in the form of an audio beep, ring-tone, flashing display, or vibration or any other method or combination thereof that alerts the user to answer the query to designate the travel event as personal or business. For example, a mobile phone may vibrate or beep when the traveler moves location or moves location far enough in a short enough interval of time which indicates that the mobile phone has a velocity (distance divided by time) that warrants querying the user as to whether a travel event is beginning and if so, what type of travel is involved. An example query may comprise a question on the screen of the portable computing device such as “P=1 or B=2” which allows the traveler to enter a “1” on the portable computing device keypad to indicate personal travel, or a “2” on the keypad to denote business travel. Alternatively, an automobile may be configured to display a “Personal Travel or Business Travel” message on the stereo console and query the user to enter “+” or “−” on the steering wheel buttons to indicate the type of travel that is to occur when the traveler starts the automobile.

After the traveler has provided a selection in response to the query, the selection is saved along with the location information at configurable intervals or as the location changes. The destination location is saved when the traveler confirms that the travel event is over, for example when the location no longer changes for a configurable time period. The travel information thus saved may be plotted and used for creating an accurate or reasonably accurate contemporaneous record of the travel events that can specifically be used, but not limited, to document the travel for business, employment, personal, tax, insurance or legal purposes.

Embodiments of the invention may also be configured to obtain pictures, video, audio or text entries. The travel event data may thus be augmented with other data that provides additional evidence that the travel event occurred and when and where it occurred. The travel event may be automatically emailed or communicated in any other way to another computing system such as for example a business computing server. The actual travel event location information may be plotted on a map and printed out or electronically associated with a spreadsheet or word processor in order to generate a report that may be printed and archived for later use. Other information may be inserted into the travel event data such as the rear pointing video on automobiles that are equipped with rear pointing video cameras in place of or augmenting rear view mirrors. In the scenario where a travel event results in a crash, the video data immediately proceeding the crash may be saved when the computing device associated with the vehicle records an acceleration that is indicative of a crash. In the case of hit and run, the video data may be utilized by law enforcement or by insurance companies in order to determine fault and to find the other vehicle involved in the crash.

An example report generated by an embodiment of the invention may comprise numerous items of data that can provide useful specific information including, but not limited to; the date, time, and distance of a travel event; the starting location of a travel event; the defined destination of the travel event; the map coordinates of the travel event; the recorded message of the travel event; the trip mileage of the travel event; the trip purpose of the travel event; the average speed of the trip event; the miles per hour of the travel during any portion of the travel event; and other such event information useful, beneficial, and critical to commerce, personal, legal, insurance and other such uses that the device and methods can provide. Embodiments of the invention may integrate with spreadsheets (such as Excel®), word processors (such as Word®), personal information management programs (such as Outlook® or Palm Desktop(®) or accounting software (such as Quickbooks(®). Travel data may be sent electronically to another computing device through a network connection, a wireless network connection, over Bluetooth® or optically using an infrared device.

Embodiments of the invention may be provided to a traveler through various methods including subscription based services purchased through a cell phone provider for example. Alternatively, the user may purchase a software module over the Internet for example that provides the methods of embodiments of the invention. Any other method of obtaining the functionality provided by embodiments of the invention may be employed. For example, a user may “beam” an application from one PDA to another PDA and the application may provide functionality of an embodiment of the invention. Likewise, the software may be preinstalled on cell phones or in automobiles or other vehicles so that the traveler does not have to download and install the software.

In one or more embodiments of the invention, the travel event data is saved to a secure server saved in a read-only format so that the user cannot change or manipulate the data in any way. This may be accomplished by transmitting the data to a business server that the traveler does not have “modify” authorization on. Alternatively, the file data may be digitally signed and/or encrypted on the portable computing device and may be in a format such as binary format that the user may not readily manipulate. Embodiments that employ steps that do not allow for a traveler to modify travel event data provide a higher standard of independent evidence that the travel event occurred and when and where it occurred.

### DESCRIPTION OF THE DRAWINGS

The above and other aspects, features and advantages of the invention will be more apparent from the following more particular description thereof, presented in conjunction with the following drawings wherein:

FIG. 1 is an architectural view of the system showing a GPS satellite that communicates with a traveler's portable computing device that is configured in accordance with an embodiment of the invention and associated with a moving vehicle or during a meeting along with the Internet, and a traveler's home or a contract facility.

FIG. 2 is a flow chart depicting an embodiment of the tracking method utilized with a portable computing device.

FIG. 3 is an example of a spreadsheet report generated in accordance with a tracked venture as documented by an embodiment of the invention.

FIG. 4 is an example of mapping functionality used for displaying both graphical and textual information for a tracked venture as documented by an embodiment of the invention.

### DETAILED DESCRIPTION

A system and method for documenting a travel event and designating the travel event as business or personal will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

Embodiments of the invention enable the automated process of documenting travel events as business or personal related and are utilized in maintaining accurate records for business, employment, personal, tax, insurance or legal purposes. Embodiments of the invention allow for private and government organizations that have a need for recording travel events associated with employees to designate travel as business or personal related. Embodiments of the invention may be utilized by sales personnel, real estate professionals, repair personnel and others are generally required to travel for business purposes and document that travel for reimbursement or tax related purposes. In addition, embodiments of the invention allow for local, county, state and federal government employees to provide mileage documentation in order to obtain reimbursement. The system may be used by the department of motor vehicles to determine what registration amount is to be charged annually for a driver based on the number of personal and business miles that the traveler drives annually. The rate may also be based on the location of driving, for example be based on the number of highway miles versus the number of street miles that a person drives per year. In addition, miles that are driven out of state may be deducted from the total number of miles and in this manner a driver is actually charged for the amount of mileage performed by the driver in state.

Embodiments of the invention allow for a travel event that has been designated as business or personal to be utilized by an external company for purposes of verifying the travel event. For example, an external company such as an insurance company may provide incentives to drivers that stay under the speed limit (which is based on the location of travel). Furthermore, the insurance company may require verification of business versus personal travel for rate coverage incentives. An insurance company may also designate and obtain dangerous hours of vehicle operation to determine for example if a young driver is often driving around closing time for drinking establishments. As a traveler attempting to hide travel at dangerous hours may not wish to carry a cell phone that would be able to track the traveler's speed and time of travel, the computing elements of a vehicle equipped with location determination functionality may also be utilized to document travel. In this example, the vehicle queries the traveler as to the nature of travel (e.g., business or personal travel) at travel start time and downloads the travel speed and time information to a user's cell phone or PDA or directly over the Internet to the insurance company's server at travel completion (or at the time of an accident). The travel data that has been designated as business or personal in an un-editable form may subsequently be used in legal proceedings to prove that a traveler was or was not obeying the law at the time of the accident. In the case of travel for business, a business insurance policy may cover an accident while personal travel may be covered by a personal insurance policy. In a scenario where the same traveler in the same vehicle (car, boat, motorcycle or any other moving vehicle having a computer and GPS receiver) may have an accident that is covered by more than one insurance policy. Embodiments of the invention therefore may be utilized in discerning whether the travel was pre-designated as business or personal in an unchangeable method after an accident has occurred.

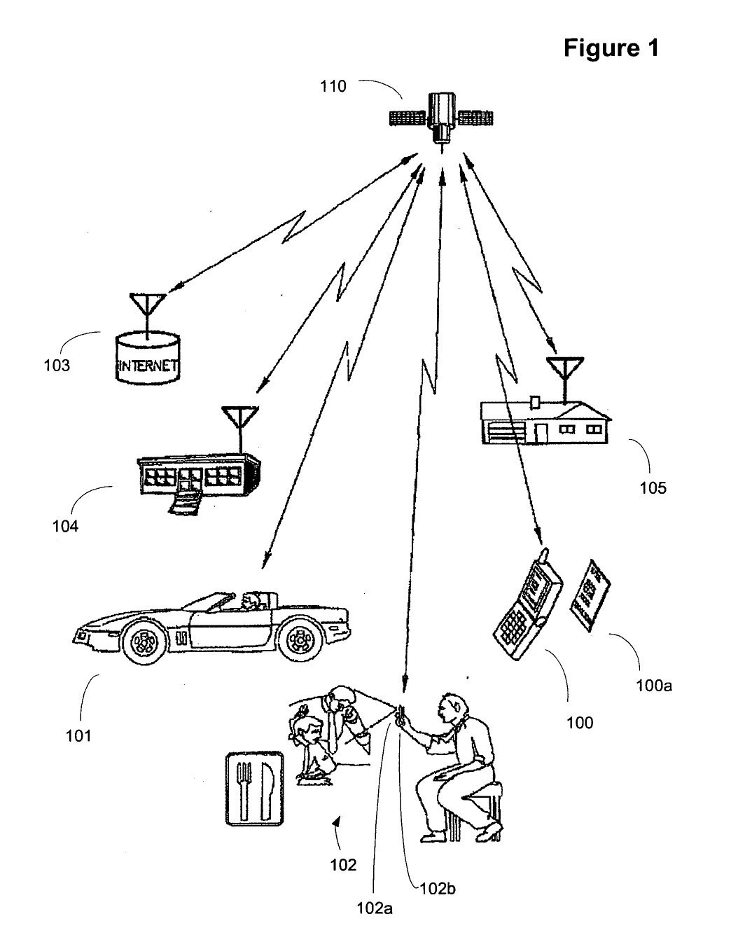

Embodiments of the invention may utilize computing devices that are portable by a human or vehicle. FIG. 1 is an architectural view of the system showing satellite 110 that communicates with a traveler's portable computing device 100 that is configured in accordance with an embodiment of the invention and may be placed in moving vehicle 101 or at meeting 102. In embodiments utilizing a car computer and automobile with GPS functionality, moving vehicle 101 may be utilized interchangeably as portable computing device 100. Satellite 110 may comprise communications functionality and/or GPS transmission functionality. Any other method of communication between Internet 103 and portable computing device 100 is in keeping with the spirit of the invention. Additionally, Internet 103, and traveler's home 105 and contract facility 104 are shown as other possible locations where embodiments of the invention may be utilized.

Portable computing device 100 refers to a cell phone, mobile phone, portable phone. wireless or Bluetooth® capable Personal Digital Assistant (PDA), car computer or any other computing device that is portable and that is configured to obtain location and time information or is equipped with location determination functionality and clock functionality. For example, a notebook computer with a GPS card and wireless network card is an example of a portable computing device that may be utilized in one or more embodiments of the invention. Automobile 101 is an example of a portable computing device as modern automobiles generally have multiple central processing units. The automobile ports the central processing unit(s) coupled with the vehicle through space and time. Many automobiles and other vehicles are now available with GPS position determination functionality. Any other vehicles such as boats, motorcycles or any computer devices that may be ported by any vehicle which have at least one microprocessor and the ability to obtain location and time information are in keeping with the spirit of an invention. By obtaining location and optionally time information from satellite 110 when satellite 110 is for example equipped with GPS transmission equipment, travel event data may be saved with location information and time information. Optionally, cell towers or other equipment may be utilized to obtain location information. Contract facility 104 may comprise a cell tower and/or antenna for example. Any other computer devices that generally have microprocessor controllers and the ability to obtain location and time information are in keeping with the spirit of an apparatus that may be utilized with an embodiment of the invention. Time information may comprise hours, minutes, seconds and any division of a second and may also include the day of the week, the date of the month, the month and the year.

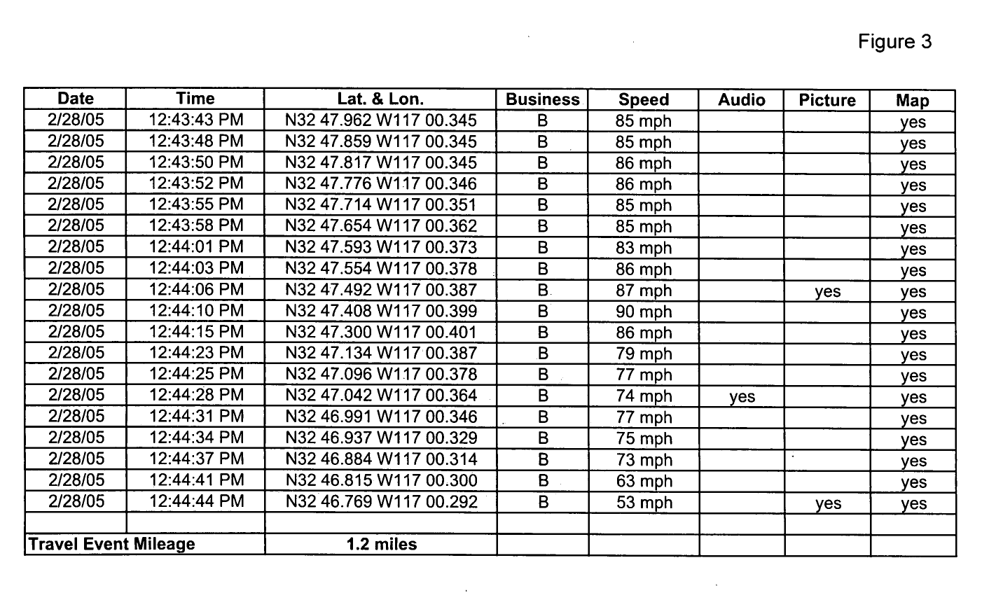

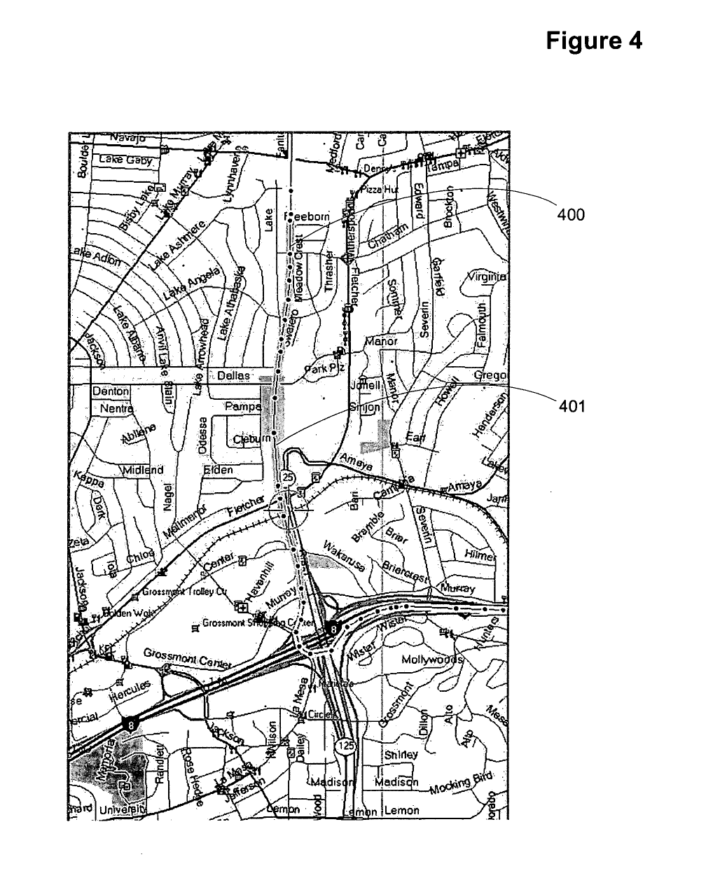

Optional elements such as portable computing display 100a, video camera 102a, sound recorder on portable computing device 102b, and other software functionality for performing various functions may be utilized in one or more embodiments of the invention to augment the core functionality of the system. Portable computing display 100a may be configured to show a spreadsheet, map, email program, word processor or other application that employs embodiments of methods of the invention. Alternatively, an external spreadsheet program (See FIG. 3) may be utilized in displaying the travel event data. Travel event data may be displayed as map data (See FIG. 4) and may be exported and displayed in other programs or utilized with embodiments of the invention in reports. Video camera 102a may be utilized to provide additional evidence that the travel event occurred by saving a picture of meeting 102 along with the travel event data. Although video camera 102a, is shown on portable computing device 102b, this does not limit the origin of any multimedia such as pictures, videos or audio that may be captured by another device and transferred to an embodiment of the invention and saved along with the travel event data, such as for example the rear pointing video cameras that are installed on some types of automobiles.

In one or more embodiments of the invention, travel event data that is stored during a travel event is stored in such a manner as to render the travel event data read only. By preventing the traveler from modifying travel event data, a higher standard of evidence is thus produced. The travel event data may be stored in a binary file, may be signed, may be encrypted or may be transferred to another computer that does not allow the user to modify the data. A data escrow company at contract facility 104 for example may be utilized in saving off travel event data in an application service provider environment so that the data is always independently stored outside of the realm where the traveler may modify the data. Such security may be necessary for certain business, employment, personal, tax, insurance or legal purposes. In other circumstances, such security may not be required, for example for simple travel reimbursements for an employee.

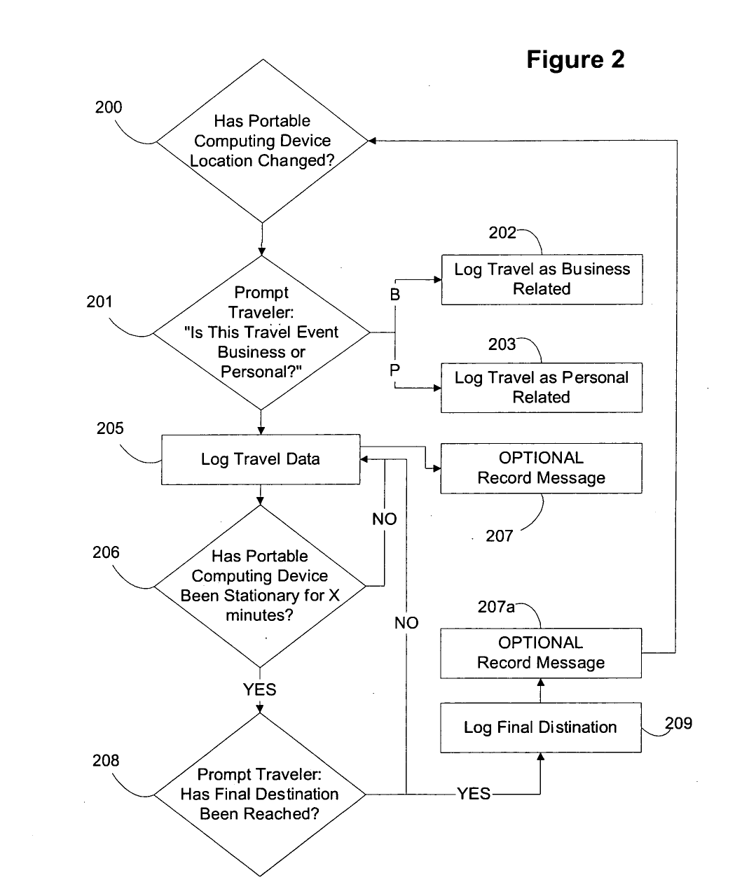

FIG. 2 is a flow chart depicting an embodiment of the tracking method utilized with a portable computing device. Embodiments of the invention obtain a location utilizing a portable computing device. In one or more embodiments of the invention, the location divided by the time interval between location samples is utilized to determine the velocity of the portable computing device at 200. After obtaining a location, embodiments of the invention query a user when the location changes and the traveler begins a travel event at 201. The query may be in the form of an audio beep, ring-tone, flashing display, car console text message or voice query, or vibration or any other method or combination thereof that alerts the user to answer the query to designate the travel event as personal or business. For example, a mobile phone may vibrate or beep when the traveler moves location or moves location far enough in a short enough interval of time which indicates that the mobile phone has a velocity (distance divided by time) that warrants querying the user as to whether a travel event is beginning and if so, what type of travel is involved. An example query may comprise a question on the screen of the portable computing device such as “P=1 or B=2” which allows the traveler to enter a “1” on the portable computing device keypad to indicate personal travel, or a “2” on the keypad to denote business travel. If the traveler enters “B” (or “1”) at 201, then the travel event data is flagged as personal travel at 202 in the log. Alternatively, an automobile may be configured to display a “Personal Travel or Business Travel” message on the stereo console and query the user to enter “+” or “−” on the steering wheel buttons to indicate the type of travel that is to occur when the traveler starts the automobile. Any other type of entry in the vehicle or with the portable computing device including voice responses that are interpreted for example by voice recognition software are in keeping with the spirit of the invention. A selection may be made by default, for example if the user does not select “P” or “B” then the selection may default to “P” for personal use. In this example, the selection is performed by the portable computing device as a configurable default. The default selection may be “B” for a company car.

The travel event data for personal data may be kept in a separate data file or location with respect to business travel. Alternatively, the personal and business data may be stored in the same file and designated as personal and business related therein. If the user enters “P” (or “2”) at 201, then the system designates the travel as business related at 205 in the log. Processing returns to step 201 and flows to 205. Travel event data is routed to the log at 205 until the traveler signifies otherwise. If the device has not moved in a configurable amount of time (“x”), where “x” may be implemented as a number of minutes (for example 5) then the traveler is asked to confirm that the destination has been reached at 206. If the portable computing device has not been stationary for “x” minutes as determined by step 206, then travel event data continues to be logged at 205, otherwise processing continues to 208. While the travel event is occurring and travel event data is being logged at 205, the traveler may be prompted at 207 to record a message or picture or video, or the user may decide to perform one or more of these actions without being prompted. The multimedia data thus obtained is saved in association with the travel event data being recorded. If there is no desire by the user to record any additional data then processing continues at 208 if there has been no location change for the configurable amount of time. If the user enters “Yes” (or “1”) at 208, then the final location is logged at 209 and the user may optionally be prompted to record a multimedia entry at 207a. After recording any optional multimedia data, processing continues at 200 until travel initiates again. If the user enters “No” (or “2”) at 208, then travel event data continues to be logged at 205 and the portable computing device polls for movement for another configurable time interval at 206. The travel information thus saved may be plotted and used for creating an accurate or reasonably accurate contemporaneous record of the travel events that can specifically be used, but not limited, to document the travel for business, employment, personal, tax, insurance or legal purposes and may be sent and/or utilized to a third party or external company for any such purpose.

Embodiments of the invention may be configured to obtain pictures, video, audio or text entries at 207 and 207a. The travel event data may thus be augmented with other data that provides additional evidence that the travel event occurred and when and where it occurred. The travel event may optionally be automatically emailed or communicated in any other way to another computing system such as for example a business computing server. The actual travel event location information may be plotted on a map and printed out or electronically associated with a spreadsheet, personal information manager, accounting software package or word processor in order to generate a report that may be printed and archived for later use. (See FIGS. 3 and 4). Other information may be inserted into the travel event data such as the rear pointing video on automobiles that are equipped with rear pointing video cameras in place of or augmenting rear view mirrors. In the scenario where a travel event results in a crash, the video data immediately proceeding the crash may be saved when the computing device associated with the vehicle records an acceleration that is indicative of a crash. In the case of hit and run, the video data may be utilized by law enforcement or by insurance companies in order to determine fault and to find the other vehicle involved in the crash.

An example report generated by an embodiment of the invention may comprise numerous items of data that can provide useful specific information including, but not limited to; the date, time, and distance of a travel event; the starting location of a travel event; the defined destination of the travel event; the map coordinates of the travel event; the recorded message of the travel event; the trip mileage of the travel event; the trip purpose of the travel event; the average speed of the trip event; the miles per hour of the travel during any portion of the travel event; and other such event information useful, beneficial, and critical to commerce, personal, legal, insurance and other such uses that the device and methods can provide. FIG. 3 shows an example of a report in spreadsheet format. Embodiments of the invention may integrate with spreadsheets (such as Excel®), word processors (such as Word®), personal information management programs (such as Outlook® or Palm Desktop®) or accounting software (such as Quickbooks(®). Travel data may be sent electronically or emailed to another computing device through a network connection, a wireless network connection, over Bluetooth® or optically using an infrared device.

FIG. 3 shows the travel event data in spreadsheet format with columns for date, time (which may optionally include date), latitude and longitude, business flag (B for business, P for personal), speed at the given location, audio, picture (which may comprise a video) and map. Optionally, a text column may be employed for a traveler to notate text messages along the travel. The audio and picture columns may comprise clickable hyperlinks that show or play the audio, picture or video clip that occurred at the given location in the row. The row having time “12:44:10” shows that the driver was driving at 90 mph. An insurance company obtaining this information may may for example query the user as to the nature of the trip in order to confirm that there was an emergency, or entirely cancel the traveler's insurance. Audio and picture cells having “yes” in them allow for the hyperlinks in these cells to display the audio, picture or video associated with the location. The travel event mileage is displayed in the lower portion of the travel event. This short travel is exemplary and much larger trips having varying distances between location sample points is in keeping with the spirit of the invention. The actual travel event data may be clicked on with a mouse in each cell to show the segment of travel event data in a map as shown in FIG. 4.

FIG. 4 shows the travel event data that is displayed in FIG. 3. The travel event data segment 400 shows the start of the business travel, wherein a traveler designated the trip as travel. This may be at the start of motion of the car or once the car has passed a point where the travel would have turned off for personal travel. In any event, once a travel event has been recorded, the travel event data is logged from that point on until the traveler designates otherwise. The entry at “12:44:10 PM” having speed 90 mph is shown as segment 401 in FIG. 4. This segment may be designated as red or in any other color on the map to indicate the severity of the speed. FIG. 3 may be scrollable and in this case does not show the final destination point where speed equals zero.

Embodiments of the invention may be provided to a traveler through various methods including subscription based services purchased through a cell phone provider for example. Alternatively, the user may purchase a software module over the Internet for example that provides the methods of embodiments of the invention. Any other method of obtaining the functionality provided by embodiments of the invention may be employed. For example, a user may “beam” an application from one PDA to another PDA and the application may provide functionality of an embodiment of the invention. Likewise, the software may be preinstalled on cell phones or in automobiles or other vehicles so that the traveler does not have to download and install the software.

While the invention herein disclosed has been described by means of specific embodiments and applications thereof, numerous modifications and variations could be made thereto by those skilled in the art without departing from the scope of the invention set forth in the claims.

What is claimed is:

1. A system for documenting a travel event and designating the travel event as business or personal comprising:
a portable computing device wherein said portable computing device comprises a mobile phone or computer coupled with a vehicle;
said portable computing device configured to obtain a location;
said portable computing device configured to obtain a time;
said portable computing device configured to query a traveler when said location changes;
said query comprising a presentation of a choice for said traveler to choose from that designates a travel event as personal or business;
said portable computing device configured to save a selection that designates personal or business wherein said selection is saved in travel event data;
said portable computing device configured to record said location during said travel event in said travel event data;
said portable computing device configured to confirm said travel event has completed when said location no longer changes; and,
said portable computing device configured to save a destination location in said travel event data.

2. The system of claim 1 wherein said travel event data cannot be modified by said traveler and wherein said travel event data is stored in an encrypted or binary format.

3. The system of claim 1 wherein said travel event data is transferred to a computer where said travel event data cannot be modified by said traveler.

4. The system of claim 1 wherein said travel event data is transferred to a computer owned by a third party wherein said travel event data cannot be modified by said traveler and wherein said travel event data is used by an insurance company or department of motor vehicles.

5. The system of claim 1 wherein said query comprises a vibration transmitted by said portable computing device, a flash on a screen coupled with said portable computing device, an audio query generated by said portable computing device through a speaker coupled with said portable computing device, a ring-tone query generated by said portable computing device through a speaker coupled with said portable computing device and wherein said ring-tone comprises an audio clip that asks said user to enter a selection that represents personal or business or text message displayed on a car console.

6. The system of claim 1 wherein said travel event data further comprises a multimedia data entry and wherein said multimedia data entry comprises a picture, video or audio recording.

7. The system of claim 1 wherein said travel event data is integrated with a spreadsheet, personal information manager, accounting software package or a word processor.

8. The system of claim 1 wherein said travel event data is transferred from said portable computing device over a communications link electronically or utilizing wireless components or via email.

9. The system of claim 1 wherein said travel event data is used to provide a contemporaneous record of said travel event for a business, employment, personal, tax, insurance or legal purpose.

10. The system of claim 1 wherein said travel event data is used to reimburse an employee for business travel.

11. A method for documenting a travel event and designating the travel event as business or personal comprising:
obtaining a location with a portable computing device wherein said portable computing device comprises a mobile phone or computer coupled with a vehicle;
obtaining a time with said portable computing device;
querying a traveler when said location changes to designate a travel event as personal or business;
saving a selection that results from said querying wherein said selection comprises a representation of said travel as personal or business and wherein said selection is saved in travel event data;
recording said location during said travel event in said travel event data;
confirming said travel event has completed when said location no longer changes; and,
saving a destination location in said travel event data.

12. The method of claim 11 further comprising preventing said travel event data from being modified by said traveler and wherein said travel event data is stored in an encrypted or binary format.

13. The method of claim 11 further comprising transferring said travel event data to a computer wherein said travel event data cannot be modified by said traveler.

14. The method of claim 11 further comprising transferring said travel event data to a computer owned by a third party where said travel event data cannot be modified by said traveler and wherein said travel event data is used by an insurance company or department of motor vehicles.

15. The method of claim 11 wherein said querying comprises use of a vibration transmitted by said portable computing device, a flash on a screen coupled with said portable computing device, an audio query generated by said portable computing device through a speaker coupled with said portable computing device, a ring-tone query generated by said portable computing device through a speaker coupled with said portable computing device and wherein said ring-tone comprises an audio clip that asks said user to enter a selection that represents personal or business or text message displayed on a car console.

16. The method of claim 11 further comprising saving a multimedia data entry associated with said travel event data and wherein said multimedia data entry comprises a picture, a video or an audio recording.

17. The method of claim 11 further comprising integrating said travel event data into a spreadsheet, personal information manager, accounting software package or a word processor.

18. The method of claim 11 further comprising transferring said travel event data to a second computer over a communications link electronically or utilizing wireless components or via email.

19. The method of claim 11 further comprising providing a contemporaneous record of said travel event for a business, employment, personal, tax, insurance or legal purpose.

20. The method of claim 11 further comprising reimbursing an employee for business travel.
